(19) United States
(12) Patent Application Publication
(10) Pub. No.: US 2015/0380188 A1
(43) Pub. Date: Dec. 31, 2015

(54) Gas Circuit Breaker

(71) Applicant: HITACHI, LTD., Chiyoda-ku, Tokyo (JP)

(72) Inventors: Toshiaki SAKUYAMA, Tokyo (JP); Hajime URAI, Tokyo (JP); Noriyuki YAGINUMA, Tokyo (JP)

(21) Appl. No.: 14/765,497

(22) PCT Filed: Mar. 5, 2014
(86) PCT No.: PCT/JP2014/055537

§ 371 Date: Aug. 3, 2015

(30) Foreign Application Priority Data
Apr. 18, 2013 (JP) 2013-087031

(51) Int. Cl. H01H 33/08; H01H 73/18

(52) U.S. Cl. CPC H01H 33/08; H01H 73/18; H01H 2205/002

(57) ABSTRACT

A gas circuit breaker includes, in a container filled with an arc extinguishing gas: a fixed-side main contact and a movable-side main contact separable from the fixed-side main contact; a fixed arcing contact (12) and a movable arcing contact (11) disposed on inside diameter sides of the fixed-side main contact and the movable-side main contact, respectively, the movable arcing contact (11) being separable from the fixed arcing contact (12); an insulating nozzle (14) that surrounds the fixed arcing contact (12); an arc space to be formed between the fixed arcing contact (12) in the insulating nozzle (14) and the movable arcing contact (11) when the movable arcing contact (11) is separated from the fixed arcing contact (12); a thermal puffer chamber (21) that draws thereinto the arc extinguishing gas whose pressure has been increased by arc heat in the arc space; and an evaporating member (41) disposed in the thermal puffer chamber (21). In the gas circuit breaker, the evaporating member (41) is formed of a nonwoven fabric.

### TECHNICAL FIELD

The present invention relates generally to puffer type gas circuit breakers and, more particularly, to a circuit breaker that uses mechanical compression action and heating and pressurizing action by arc heat.

### BACKGROUND ART

Gas circuit breakers are used for interrupting short-circuit currents in electric power systems. Puffer type gas circuit breakers have been widely used. The puffer type gas circuit breaker includes a movable puffer cylinder directly connected to a movable arcing contact. The movable puffer cylinder mechanically compresses an arc extinguishing gas to generate a high-pressure gas flow. Thus-generated high-pressure gas flow is blown against an arc produced across the movable arcing contact and a fixed arcing contact to thereby interrupt a current. The ability of interrupting currents greatly depends on pressure-rise in a puffer chamber. Since the pressure-rise, however, is a counter force acting in opposition to a driving force, achieving the high ability of interruption requires a large driving force.

Many devices have been developed with the aim of achieving the high ability of interruption, while reducing the driving force. An example of such devices is a gas circuit breaker using in combination thermal puffer, the gas circuit breaker increasing pressure using positively thermal energy of arcing as well as mechanical compression. known in the art. The thermal puffer-combined gas circuit breaker uses the arcing thermal energy to form blowing pressure for the arc extinguishing gas, allowing operating energy required for an interrupting operation to be reduced as compared with the mechanical compression known in the art. The formation of the blowing pressure using the arcing thermal energy, however, involves high arc extinguishing gas temperatures during blowing, resulting in degraded ability of interruption. Attempts have thus been made to improve the ability of interruption by lowering the temperature of the arc extinguishing gas to be blown.

Patent Document 1 discloses a gas circuit breaker developed with the aim of allowing steady, high ability of interruption to be achieved by preventing insulation deterioration and metal material corrosion caused by moisture produced from a polymer release gas.

In the gas circuit breaker disclosed in Patent Document 1, part of the arching energy is used to heat attachment part disposed inside an accumulator to thereby generate ablation release gas. This allows the concentration of a blowing gas to be further improved, so that the blowing gas is a mixture of the arc extinguishing gas and the release gas, thus enhancing cooling capacity of the gas. Patent Document 1 then concludes that the foregoing achieves steady, high ability of interruption.

In the gas circuit breaker disclosed in Patent Document 1, the attachment part is formed as a sheet or a coating layer and has a porous, honeycomb, or multi-layered structure, to thereby increase a greater surface area for a greater amount of release gas.

### PRIOR ART DOCUMENTS

### Patent Documents

Patent Document 1: JP-2003-297200-A

### SUMMARY OF THE INVENTION

### Problem to be Solved by the Invention

The thermal puffer-combined gas circuit breakers, including that known in the art that includes the attachment part disposed with the aim of achieving the high ability of interruption by increasing the release gas by ablation, however, have the following problems.

To increase the area of contact with the arc extinguishing gas, the attachment part needs to be machined to be porous. Attaching the attachment part to a narrow small portion requires micro-machining, leading to increased cost.

It is an object of the present invention to solve these problems of the gas circuit breakers known in the art. Specifically, an object of the present invention is to achieve steady, high ability of interruption easily and at low cost without involving increased weight of movable parts.

### Means for Solving the Problem

To solve the abovementioned problems, an aspect of the present invention provides a gas circuit breaker comprising, in a container filled with an arc extinguishing gas: a fixed-side main contact and a movable-side main contact separable from the fixed-side main contact; a fixed arcing contact and a movable arcing contact disposed on inside diameter sides of the fixed-side main contact and the movable-side main contact, respectively, the movable arcing contact being separable from the fixed arcing contact; an insulating nozzle that surrounds the fixed arcing contact; an arc space to be formed between the fixed arcing contact in the insulating nozzle and the movable arcing contact when the movable arcing contact is separated from the fixed arcing contact; a thermal puffer chamber that draws thereinto the arc extinguishing gas whose pressure has been increased by arc heat in the arc space; and a nonwoven fabric as an evaporating member disposed in the thermal puffer chamber.

### Effects of the Invention

In the present invention, the nonwoven fabric as the evaporating member is disposed inside the thermal puffer chamber. This arrangement increases an area of contact of the evaporating member with the arc extinguishing gas to thereby increase an evaporated amount. A highly concentrated evaporative gas generated through the evaporation mixes with the arc extinguishing gas, which reduces the temperature of the arc extinguishing gas to be blown. The blowing of the arc extinguishing gas at low temperature against the arc enhances the ability of interruption.

The nonwoven fabric, is thin and flexible and thus easily mountable as the evaporating member. The nonwoven fabric further facilitates mounting onto a narrow small portion.

The present invention can thus provide a gas circuit breaker that achieves steady, high ability of interruption easily and at low cost.

### BRIEF DESCRIPTION OF THE DRAWINGS

FIG. 1 is a cross-sectional view showing a condition of a thermal puffer chamber during arcing according to a first embodiment of the present invention.

FIG. 2 is a cross-sectional view showing a condition of a thermal puffer chamber during arcing according to a second embodiment of the present invention.

FIG. 3 is a cross-sectional view showing a condition of a thermal puffer chamber during arcing according to a third embodiment of the present invention.

FIG. 4 is a cross-sectional view showing a condition of a thermal puffer chamber during arcing according to a fourth embodiment of the present invention.

FIG. 5 is a cross-sectional view showing a condition of a thermal puffer chamber during arcing according to a fifth embodiment of the present invention.

### MODES FOR CARRYING OUT THE INVENTION

Embodiments of the present invention will be described below with reference to the accompanying drawings. The following embodiments are illustrative of the invention and are not to be construed as limiting thereof. Various changes in form and detail may be made therein without departing from the spirit and scope of the invention.

### First Embodiment

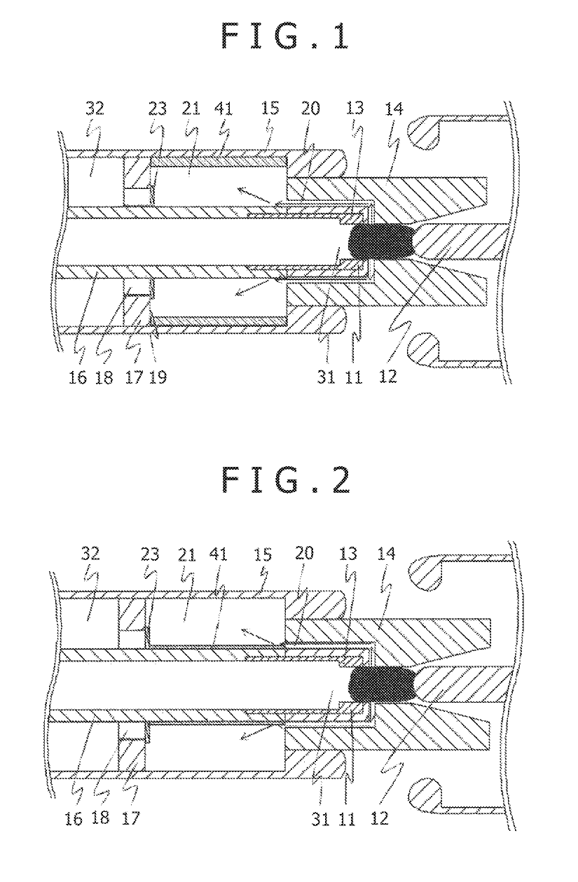

FIG. 1 is a cross-sectional view showing an interrupting section of a gas circuit breaker according to a first embodiment to which the present invention is applied. An evaporating member 41 formed of a nonwoven fabric is disposed on an inner peripheral surface of a cylinder 15, the inner peripheral surface of the cylinder 15 constituting an outer peripheral surface of a thermal puffer chamber 21. Contact between an arc extinguishing gas at high temperature flowing into the thermal puffer chamber 21 and the evaporating member 41 during current interruption generates an evaporative gas from the evaporating member.

The following describes operations during current interruption. Driving a hollow rod 16 using an operating unit (not shown) causes a movable arcing contact 11, a movable contact cover 13, an insulating nozzle 14, the cylinder 15, a bulkhead 17, and the thermal puffer chamber 21 to be displaced toward the left in FIG. 1, establishing an open circuit condition. At this time, an arc occurs in an arc space 31 formed between the movable arcing contact 11 and a fixed arcing contact 12.

The arc extinguishing gas in the arc space 31 increases its temperature as its pressure builds up. As shown in FIG. 1, the highly pressurized arc extinguishing gas at high temperature flows into the thermal puffer chamber 21 at high speed via a flow path 20. This causes thermal energy of the arc to be trapped in the thermal puffer chamber 21. The arc extinguishing gas in the thermal puffer chamber 21 is then heated and pressure inside the thermal puffer chamber 21 increases rapidly.

The arc extinguishing gas that has flowed into, and diffused in, the thermal puffer chamber 21 contacts the evaporating member 41 disposed on an outer periphery inside the thermal puffer chamber 21, causing an evaporative gas to be produced from the evaporating member 41. The evaporative gas increases the pressure in the thermal puffer chamber 21 further. A highly concentrated evaporative gas generated by the evaporation mixes with the arc extinguishing gas to thereby reduce the temperature of the arc extinguishing gas to be blown.

The evaporating member 41 formed of the nonwoven fabric offers a large area of contact with the arc extinguishing gas. Moreover, the evaporating member 41 is disposed on the outer peripheral surface of the thermal puffer chamber 21. Thus, the evaporating member 411 is disposed on a large area, allowing an evaporated amount to be increased.

The evaporating member 41 evaporates through its contact with the arc extinguishing gas at high temperature, decreasing its thickness. The evaporating member 41 is desirably able so withstand a large number of interruptions of large currents. Thus, nonwoven fabric sheets need to be stacked one on top of another, so that the evaporating member 41 has a thickness of several millimeters.

A stack of nonwoven fabric sheets is processed into a pipe or sheet shape to form the evaporating member 41. When, for example, the evaporating member 41 is disposed on the inner peripheral surface of the cylinder 15, specifically, the outer peripheral surface of the thermal puffer chamber 21, the evaporating member 41 is processed into a pipe shape having an outside diameter equal to, or smaller than, an inside diameter of the cylinder 15; the evaporating member 41 is then fixed in place so as to be aligned with an axis of the thermal puffer chamber 21 and so as to be clamped between the bulkhead 17 and a surface of the cylinder 15 facing the bulkhead 17. When the evaporating member 41 is disposed at a mounting position 19 on an outer peripheral side of the bulkhead 17 in the thermal puffer chamber 21, a nonwoven fabric-stacked sheet is fixed as the evaporating member.

### Second Embodiment

FIG. 2 is a cross-sectional view showing an interrupting section of a gas circuit breaker according to a second embodiment to which the present invention is applied. An evaporating member 41 formed of a nonwoven fabric is disposed on an outer peripheral surface of a hollow rod 16, the outer peripheral surface of the hollow rod 16 constituting an inner peripheral surface of a thermal puffer chamber 21. Contact between an arc extinguishing gas at high temperature flowing into the thermal puffer chamber 21 and the evaporating member 41 during current interruption generates an evaporative gas from the evaporating member.

The following describes operations during current interruption. Driving the hollow rod 16 using an operating unit (not shown) causes a movable arcing contact 11, a movable contact cover 13, an insulating nozzle 14, a cylinder 15, a bulkhead 17, and the thermal puffer chamber 21 to be displaced toward the left in FIG. 1, establishing an open circuit condition. At this time, an arc occurs in an arc space 31 formed between the movable arcing contact. 11 and a fixed arcing contact 12.

The arc extinguishing gas in the arc space 31 increases its temperature as its pressure builds up. As shown in FIG. 2, the highly pressurized arc extinguishing gas at high temperature flows into the thermal puffer chamber 21 at high speed via a flow path 20. This causes thermal energy of the arc to be trapped in the thermal puffer chamber 21. The arc extinguishing gas in the thermal puffer chamber 21 is then heated and pressure inside the thermal puffer chamber 21 increases rapidly.

The arc extinguishing gas that has flowed into, and diffused in, the thermal puffer chamber 21 contacts the evaporating member 41 disposed on an inner periphery inside the thermal puffer chamber 21, causing an evaporative gas to be produced from the evaporating member 41. The evaporative gas increases the pressure in the thermal puffer chamber 21 further. A highly concentrated evaporative gas generated by the evaporation mixes with the arc extinguishing gas to thereby reduce the temperature of the arc extinguishing gas to be blown. The evaporating member 41 formed of the nonwoven fabric offers a large area of contact with the arc extinguishing gas. Moreover, she evaporating member 41 is disposed on the inner peripheral surface of the thermal puffer chamber 21. Thus, the arc extinguishing gas maintaining a high temperature contacts the evaporating member 41. This allows an evaporated amount to be increased.

### Third Embodiment

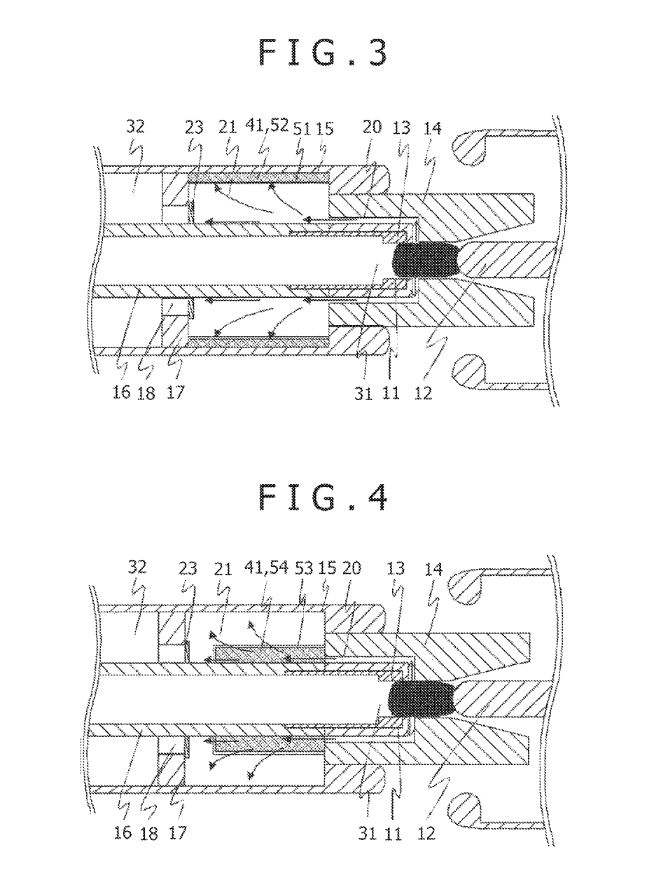

FIG. 3 is a cross-sectional view showing a gas circuit. breaker according to a third embodiment to which the present invention is applied. In a thermal puffer chamber 21, an outer peripheral space 52 is formed by a cylinder 15 that constitutes an outer peripheral surface of the thermal puffer chamber 21, a bulkhead 17, and a partition member 51. An evaporating member formed of a nonwoven fabric is housed irregularly inside the outer peripheral space 52. The partition member 51 has a mesh-like opening. An arc extinguishing gas and an evaporative gas flow in and out of the thermal puffer chamber 21 and the outer peripheral space 52 through the partition member 51.

During current interruption, the high-temperature arc extinguishing gas that flows into the thermal puffer chamber 21 from an arc space 31 through a flow path 20 diffuses in the thermal puffer chamber 21 and flows through the partition member 51 into the outer peripheral space 52. The arc extinguishing gas that has flowed in contacts the evaporating member formed of the nonwoven fabric and a highly concentrated evaporative gas generated through the evaporation mixes with the arc extinguishing gas, which reduces the temperature of the arc extinguishing gas to be blown.

FIG. 4 is a cross-sectional view showing a gas circuit breaker according to a fourth embodiment, to which the present invention is applied. In a thermal puffer chamber 21, an inner peripheral space 54 is formed. by a hollow rod 16 that constitutes an inner peripheral surface of the thermal puffer chamber 21 and a partition member 53. An evaporating member formed of a nonwoven fabric is housed irregularly inside the inner peripheral space 54. The partition member 53 has a mesh-like opening. An arc extinguishing gas and an evaporative gas flow in and out of the thermal puffer chamber 21 and the inner peripheral space 54 through the partition member 53.

The partition member 53 has an axial length set so as not to impede movement of a movable valve 23. During current interruption, a high-temperature arc extinguishing gas, while maintaining its high temperature, flows into the inner peripheral space from an arc space 31 through a flow path 20. The arc extinguishing gas that has flowed in contacts the evaporating member formed of the nonwoven fabric inside the inner peripheral space 54 and a highly concentrated evaporative gas generated through the evaporation mixes with the arc extinguishing gas, which reduces the temperature of the arc extinguishing gas to be blown.

### Fifth Embodiment

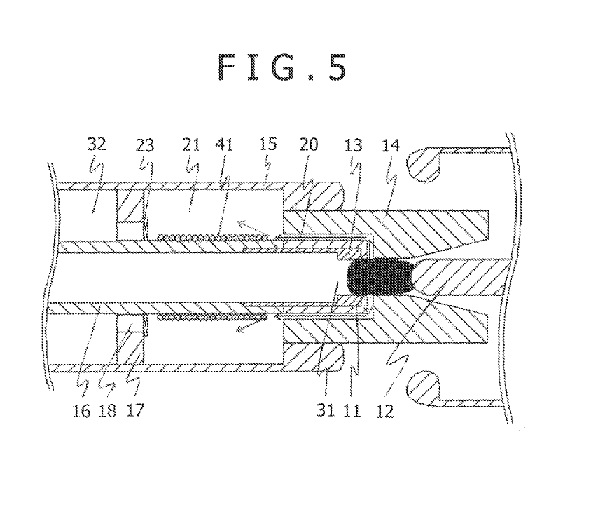

FIG. 5 is a cross-sectional view showing a gas circuit breaker according to a fifth embodiment to which the present invention is applied. An evaporating member 41 formed of a nonwoven fabric is processed into a thread. shape. The thread-like evaporating member 41 is then wound around and fixed to a hollow rod 16 that constitutes an inner peripheral surface of a thermal puffer chamber 21. During current interruption, a high-temperature arc extinguishing gas that flows in from an arc space 31 through a flow path 20 flows into an inner peripheral space, while maintaining its high temperature. The arc extinguishing gas that has flowed in contacts the evaporating member formed of the nonwoven fabric wound around the hollow rod 16 and a highly concentrated evaporative gas generated through the evaporation mixes with the arc extinguishing gas, which reduces the temperature of the arc extinguishing gas to be blown.

### DESCRIPTION OF REFERENCE NUMERALS

11: movable arcing contact
12: fixed arcing contact
13: movable contact cover
14: insulating nozzle
15: cylinder
16: hollow rod
17: bulkhead
18: through-hole
19: mounting position on an outer peripheral side
20: flow path
21: thermal puffer chamber
23: movable valve
31: arc space
32: mechanical puffer chamber
41: evaporating member
51: partition member
52: outer peripheral space
53: partition member
54: inner peripheral space

1. A gas circuit breaker comprising, in a container filled with an arc extinguishing gas:
a fixed-side main contact and a movable-side main contact separable from the fixed-side main contact;
a fixed arcing contact and a movable arcing contact disposed on inside diameter sides of the fixed-side main contact and the movable-side main contact, respectively, the movable arcing contact being separable from the fixed arcing contact;
an insulating nozzle that surrounds the fixed arcing contact;
an arc space to be formed between the fixed arcing contact in the insulating nozzle and the movable arcing contact when the movable arcing contact is separated from the fixed arcing contact;
a thermal puffer chamber that draws thereinto the arc extinguishing gas whose pressure has been increased by arc heat in the arc space; and
an evaporating member disposed in the thermal puffer chamber, the evaporating member being formed of a nonwoven fabric.

2. The gas circuit breaker according to claim 1, wherein the nonwoven fabric is disposed on an outer periphery inside the thermal puffer chamber.

3. The gas circuit breaker according to claim 1, wherein the nonwoven fabric is disposed on an inner periphery inside the thermal puffer chamber.

4. The gas circuit breaker according to claim 1, wherein the nonwoven fabric is housed in a case disposed on the outer periphery of the thermal puffer chamber.

5. The gas circuit breaker according to claim 1, wherein the nonwoven fabric is housed in a case disposed on the inner periphery of the thermal puffer chamber.

6. The gas circuit breaker according to claim 1, wherein the nonwoven fabric is processed into a thread shape wound around the inner periphery of the thermal puffer chamber.
